(19) United States
(12) Patent Application Publication
(10) Pub. No.: US 2018/0374404 A1
(43) Pub. Date: Dec. 27, 2018

(54) Shimmer Disc Or Image Apparatus And A Method Of Use Thereof

(71) Applicant: Andrew Ainge, Menston, Leeds, Yorkshire (GB)

(72) Inventor: Andrew Ainge, Menston, Leeds, Yorkshire (GB)

(73) Assignee: Andrew Ainge, Menston, Leeds, Yorkshire (GB)

(21) Appl. No.: 15/781,826

(22) PCT Filed: Dec. 6, 2016
(86) PCT No.: PCT/GB2016/053835

§ 371 Date: Jun. 6, 2018

(30) Foreign Application Priority Data
Dec. 7, 2015 (GB) 1521519.7

(51) Int. Cl. G09F 19/16; G09F 9/37

(52) U.S. Cl. CPC G09F 19/16; G09F 9/37

(57) ABSTRACT

A shimmer disc or image apparatus is provided. The apparatus includes a support member, at least one shimmer disc or member, and engagement means provided on or associated with the support member and/or shimmer disc or member for engaging the at least one shimmer disc or member to the support member in use to form an engaged position. The support member, engagement means and/or the at least one shimmer disc or member are arranged such that when engaged, at least part of the at least one shimmer disc or member is movable relative to the engagement means and/or support member in use. The at least one shimmer disc or member is arranged such that at least part of the same is able to flex in use and/or is resiliently biased to the engaged position in use.

This invention relates to improvements in shimmer disc or image apparatus imagery and to a method of using or assembling the same.

Shimmer disc apparatus or shimmer discs imagery are terms given to a type of imagery where a plurality of mirrored discs are arranged in such a manner to form a mosaic like visual image or effect. Different discs can be provided in different colours and the disc colours are manually arranged on a support board to produce the desired visual image or effect in use.

Conventionally, each shimmer disc is typically a cut piece of circular metal foil, of a size for example of 30 mm diameter, with an aperture located in the same. The support board is typically a plastic backing board with drill holes arranged in a uniform manner on the board. A user manually attaches each shimmer disc in a required location on the support board by passing a pin through the disc aperture and into a drill hole on the board. The discs are attached in such a way that air flow around the discs allows each disc to move. Light is reflected off the surface of the moving metallic discs, thereby providing a shimmering visual effect. This effect is magnified when a large number of shimmer discs are arranged next to each other in a required image pattern and the discs are viewed a distance away from the finished shimmer board.

The production of conventional shimmer disc imagery has not changed for years. It is a relatively time consuming process due to a user having to manually apply each shimmer disc onto the support board in a required manner. The imagery that can be produced using the conventional shimmer disc technology is relatively limited due to each disc being limited to a single coloured foil. Gaps exist between the circular discs when they are arranged adjacent to each other to form the shimmer disc image and it is often the case that the full effect of the imagery cannot be appreciated unless the user is standing a relatively long distance away from the front surface of the shimmer board. Thus, conventional shimmer disc imagery has tended to be used on relatively large bill board advertising, where users will inevitably be a relatively long distance away from the shimmer board surface.

It is therefore an aim of the present invention to provide improvements to shimmer disc imagery that overcomes the abovementioned problems.

It is a further aim of the present invention to provide improvements to the method of producing shimmer disc imagery that overcomes the abovementioned problems.

It is a yet further aim of the present invention to provide shimmer disc or image apparatus and a method of producing and/or using shimmer disc or image apparatus.

It is a yet further aim of the present invention to provide a shimmer disc, and a method of producing a shimmer disc.

According to a first aspect of the present invention there is provided shimmer disc or image apparatus, said shimmer disc or image apparatus including a support member; at least one shimmer disc or member; engagement means provided on or associated with the support member and/or shimmer disc or member for engaging the at least one shimmer disc or member to the support member in use to form an engaged position; the support member, engagement means and/or the at least one shimmer disc or member arranged such that when engaged, at least part of the at least one shimmer disc or member is movable relative to the engagement means and/or support member in use, characterised in that said at least one shimmer disc or member is arranged such that at least part of the same is able to flex in use and/or is resiliently biased to the engaged position in use.

The provision of the unique flexure and/or resilient biasing effect of at least part of the shimmer disc or member, at least in part, allows the production of shimmer disc imagery to be easier, faster, and be more automated compared to the prior art. The ease of production of the shimmer disc imagery has allowed the dimensions of the shimmer disc or member to be significantly reduced, thereby allowing more intricate designs to be produced. In addition, the finished shimmer disc imagery can be viewed in much closer proximity to provide an improved visual effect compared to prior art shimmer disc imagery.

Preferably the movement of the at least one shimmer disc or member relative to the engagement means and/or support member in use creates a visual shimmer effect.

Preferably the shimmer disc or member is movable as a result of air flow and/or fluid flow around the disc or member in use. This movement allows light to be reflected off at least a front surface of the disc or member in use.

Preferably at least part of the shimmer disc or member is able to flex and/or be resiliently biased relative to another part of the shimmer disc or member in use.

Preferably the at least one shimmer disc or member is arranged to flex in order to move the disc or member to the engaged position.

In one embodiment the engagement means provided on or associated with the shimmer disc or member allows said shimmer disc or member to flex and/or be resiliently biased to the engaged position in use.

Preferably a resilient biasing means or mechanism and/or a flexing means or mechanism is/are provided on or associated with the at least one shimmer disc or member and/or engagement means to allow the same to undergo flexure and/or be resiliently biased to an engaged position in use.

Preferably the engagement means provided on or associated with the at least one shimmer disc or member is an aperture or an engagement aperture defined on or through said shimmer disc or member.

Preferably at least part of an engagement means provided on or associated with the support member locates with or through the engagement aperture of the shimmer disc or member in order to form the engaged position.

Preferably the engagement means, or at least part of the engagement means, provided on or associated with at least one shimmer disc or member and/or the shimmer disc or member is movable from a disengaged position, wherein the engagement means is not able to engage with the support member, to an engaged or engaging position, wherein the engagement means is able to engaged with the support member.

Preferably the engagement aperture, or at least part of the engagement aperture, provided on or associated with the at least one shimmer disc or member is movable from a disengaged position, wherein the engagement aperture is a relatively small size, to an engaged or engaging position, wherein the engagement aperture is a relatively large or larger size.

In one embodiment the engagement aperture is a relatively small size in the disengaged position and the engaged position, and is movable to a relatively larger size during the process of engaging the disc or member to the support member in use.

In one embodiment the engagement means, resilient biasing means and/or flexing means or mechanism includes one or more cuts or cut out portions in communication or associated with the engagement aperture of the shimmer disc or member.

Preferably the one or more of the cut outs or cut out portions extend outwardly in the plane of the shimmer disc or member.

Preferably the one or more cuts or cut out portions allow at least part of the material of the shimmer disc or member surrounding or between the cuts or cut outs to flex and/or be resiliently biased in use, and preferably to flex and/or be resiliently biased forwardly, rearwardly, inwardly and/or outwardly of the shimmer disc or member surface.

In one embodiment the resilient biasing means and/or flexing means allows at least part of the shimmer disc or member to flex outwardly of the plane of the disc or member during engaging of the disc or member to the support member in use, and preferably to be resiliently biased back from the outwardly protruding position towards the plane of the disc or member in the disengaged and/or engaged positions.

Preferably the one or more cuts or cut outs are provided radially outwardly of the engagement aperture in the plane of the shimmer disc or member.

Preferably the shimmer disc or member material between the cuts or cut outs form one or more protrusion portions that are capable of flexing and/or moving in use.

Preferably the one or more protrusion portions protrude inwardly of the engagement aperture (i.e. towards a virtual centre of the engagement aperture) in the plane of the shimmer disc or member.

Preferably at least one of the protrusion portions of the shimmer disc or member is formed so as to form at least one rocker or pivot member when it engages with a surface of the engagement means on the support member in use, thereby allowing the shimmer disc or member to rock or pivot in use.

In one example, at least a top central protrusion portion of the shimmer disc or member acts as a rocker or pivot member in use.

In one example, two upper protrusion portions of the shimmer disc or member act as rockers or pivot members in use.

Preferably the at least one rocker or pivot member of the shimmer disc or member engages with a top or upper surface of a neck portion of the engagement means on the support member in use.

Preferably the at least one rocker or pivot protrusion member of the shimmer disc or member is substantially V-shaped or shaped. The point of the ‘V’ or ‘L’ typically allows the at least one protrusion member to pivot or rock relative to the engagement means on the support member in use.

Preferably the engagement means on the support member is inserted from a rear surface or side of the shimmer disc or member and moved towards a front surface or side thereof during the assembly process for the apparatus.

Preferably the front surface of the shimmer disc or member is the surface that is viewed by a user of the apparatus in use.

Preferably the material between the cuts or cut outs flex forwardly or outwardly of the front surface or plane of the shimmer disc or member during the fitting/engagement process.

Preferably the size of the engagement aperture on the shimmer disc or member is arranged so as to increase in size during the fitting/engagement process.

Preferably the engagement aperture on the shimmer disc or member is arranged to be relatively smaller in size in the disengaged position or fully engaged position compared to the aperture size during the engaging process.

In one embodiment the one or more cuts or cut outs extend or are arranged radially or substantially radially with respect to at least part of the engagement aperture or aperture centre of the shimmer disc or member.

Preferably the one or more cuts or cut outs extend radially from a top or upper part of the engagement aperture of the shimmer disc or member.

Preferably the shape, design and/or dimensions of the engagement aperture in the shimmer disc or member are different and/or smaller than the shape, design and/or dimensions at least at an end of the engagement means on the support member which locates through the engagement aperture in use.

Preferably the engagement aperture of the shimmer disc or member is of a smaller size than the size of at least the end of the engagement means which locates through the engagement aperture in use.

In one embodiment the engagement means provided on or associated with the support member includes at least one body portion which is attached to or integrally formed with the support member and protrudes outwardly therefrom, and a head or engagement end that protrudes outwardly from the body portion.

Preferably a rear surface of the head or engagement end (i.e. the surface facing towards the support member) creates a shoulder or stop portion to prevent accidental removal of the shimmer disc or member therefrom once located thereover in the engaged position in use.

Preferably the head or engagement end of the engagement means is typically located through the engagement aperture of the shimmer disc or member in use to form the engaged position.

Preferably the at least one body portion protrudes outwardly from a front surface of the support member.

Preferably the at least one body portion has a first end attached to or integrally formed with the support member and a second end to which the engagement head or end is directly or indirectly located or joined to.

In one embodiment the at least one body portion of the support member has a narrowing taper from the first end to the second end (i.e. it has a narrowing taper towards a free end of the body portion). This narrowing taper provides space for the shimmer disc or member to move in when in the engaged position.

In one embodiment a neck portion is defined or is provided between the body portion and the engagement head or end.

Preferably the shimmer disc or member sits on, is suspended from or is located on or around the neck portion when in the engaged position in use.

Preferably the neck portion has smaller dimensions than the engagement head or end of the support member to prevent or substantially prevent the shimmer disc or member from falling off or accidentally disengaging from the engagement means of the support member in use.

Preferably the resilient biasing means or flexing means associated with the aperture of the shimmer disc or member flex outwardly relative to a planar or front surface of the disc or member when located over the larger sized engagement end or head, thereby increasing the size of the engagement aperture during the engaging process. When the shimmer disc or member is located on the smaller dimensioned neck portion or body portion of the engagement means, the resilient biasing means or flexing means are biased or flex inwardly towards a front or planar surface of the shimmer disc or member, thereby reducing the size of the aperture and retaining the disc or member on the engagement means on the support member in use.

Preferably the neck portion of the engagement means on the support member is arranged relative to the body portion of the engagement means such that the shimmer disc or member remains engaged on the neck portion but is freely movable relative to the support member in use. This allows the shimmer disc or member to move in air flow or fluid flow around the disc or member, thereby allowing light to be reflected off the surface of the disc or member during this movement to provide a shimmer effect.

In one embodiment an end of the body portion to which the neck portion is joined, attached to or integrally formed with angles rearwardly away from the engagement head or end, this creates the space for the shimmer disc or member to move freely when engaged to the neck portion.

Preferably a lower surface of the body portion is angled rearwardly away from the engagement head or end. Thus, the body portion has a narrowing taper towards the engagement head or end in this example.

In one embodiment the engagement head or end is oval or substantially oval in shape.

Preferably the engagement aperture of the shimmer disc or member is circular, or at least partially circular in shape. In one example, the engagement aperture is semi-circular in shape.

Preferably at least a lower surface or edge of the shower disc or member material defining the engagement aperture is curved or substantially curved in shape.

Preferably the engagement head or end of the engagement means of the support member is curved, convexed or substantially convexed in shape, from the free end towards the support member, thereby allowing easy insertion of the shimmer disc or member aperture over the same in use.

Preferably a lower surface of the neck portion with which the shimmer disc or member locates in use is curved, convexed or substantially curved or convexed in shape.

Preferably a top or upper surface of the neck portion on which the shimmer disc or member locates in use is flat, substantially flat, planar or substantially planar in form.

Preferably the at least one rocker or pivot member of the shimmer disc or member locates on the top or upper surface of the neck portion in use in the engaged position, and preferably is suspended therefrom.

Preferably a plurality of engagement means are provided a spaced distance apart on the support member.

Preferably the plurality of engagement means are uniformally or substantially uniformally distributed on a front surface of the support member.

In one embodiment the support member is a board, planar or plate like member. Preferably the engagement means protrude outwardly from the front and/or planar surface of the support member.

Preferably each engagement means on the support member is of the same or substantially the same size, shape and/or dimensions.

Preferably each shimmer disc or member used in a particular image is of the same or substantially the same size, shape and/or dimensions.

In one embodiment the support member is provided with or includes frangible means or weakened sections thereon to allow easy cutting or separation of the support member into a required size and/or shape in use. The frangible means or weakened sections typically allow the support member to be modular in form.

In one embodiment frangible means or weakened sections are provided on, around or at least partially around or between two or more, and preferably each, engagement means on the support member.

Preferably the engagement means, the frangible means and/or weakened sections are provided in a grid like form on the support member.

In one embodiment the frangible means or weakened sections includes any or any combination of one or more cuts, grooves, channels, recesses defined in the surface of the support member and/or the like.

In one embodiment the support member includes, is provided with or associated with attachment means for allowing the support member to be attached to a surface in use.

Preferably the attachment means can include any or any combination of one or more apertures, screws, nuts and bolts, clips, ties, straps, inter-engaging members, VELCRO® (hook and loop fastening) and/or the like.

In one embodiment a rear surface of the support member is recessed relative to one or more edges thereof to allow attachment means to be located therein in use.

In one embodiment an image and/or design is printed on or provided on a front and/or rear surface of the support member (if the support member is made from a transparent material and an image can be viewed from the front of the apparatus if the image is placed on the rear surface) to which shimmer discs or members are attached to in use. Since gaps typically exist between the shimmer discs or members when located side by side on the support member, the image and/or design provided on the front and/or rear surface of the support member is typically at least partially visible to a user when viewed from a front of the apparatus. This increases the aesthetic effect of the resulting imagery in use.

Preferably one or more images and/or designs are provided on the front and/or rear surfaces of one or more shimmer discs or members, such that when a plurality of shimmer disc or members are provided in a particular arrangement relative to each other on the support member, they create an overall visual image, effect and/or design.

The image and/or design printed or provided on the front and/or rear surface of the support member can be the same image and/or design that is being created by the arrangements of the shimmer discs or members located on said support member in use, or it can be a different image and/or design.

In one embodiment the support member is formed from or includes an optically clear or transparent material, or a substantially optically clear or transparent material. This is typically advantageous in allowing an image and/or design to be printed or provided on a rear surface of the support member.

Preferably the support member is formed from or includes a plastic material, such as for example ABS (Acrylonitrile butadiene styrene) plastic material.

In one example, each support member includes 225 engagement means arranged in a grid like or suitable arrangement. However, any number of engagement means can be provided as required.

Preferably two or more support members can be arranged next to each other in abutting relationship or side by side to produce a larger support member.

Preferably the shimmer disc or member material is provided in a sheet like form.

In one embodiment the shimmer disc or member is made from or includes at least one layer of a metallic material thereon. For example, the shimmer disc or member can be made from a foil or metallic foil material.

In one embodiment the shimmer disc or member is made from a plastic material or a plastic film material, such as for example a polyurethane film, or Polyplex®.

Preferably the shimmer disc or member is made from a non-metallised material or non-metallised plastic material. This has the advantage that an image of greater clarity can be provided on the same.

Preferably the shimmer disc or member is made from a transparent or substantially transparent material. In this example, the disc or member can undergo a reverse printing procedure (i.e. the image can be provided on the rear surface of the transparent material and can be viewed by a user from a front surface of the material).

Preferably the material from which the shimmer disc or member is formed (whether for example, it is plastic, metallised and/or non-metallised) has a relatively high gloss surface finish on at least a front surface of the same which is sufficient to allow light to be reflected off the same in use to provide a shimmer like effect.

Preferably the plastic film material is provided with a metallised or vacuum metallised surface thereon, and preferably at least on a front surface thereof.

Preferably the material used for the shimmer disc or member is in the region of or approximately 100 μm thick.

Preferably each shimmer disc or member is less than approx. 30 mm in diameter or width, further preferably is less than approx. 25 mm in diameter or width, yet further preferably is less than approx. 20 mm, and further preferably is approx. 13 mm in diameter or width.

In a preferred embodiment the one or more shimmer discs or members are circular or substantially circular in shape. However, the one or more shimmer discs or members could be any or any combination of the same or different shapes.

Preferably a desired image and/or design is printed on the sheet like material prior to one or more shimmer discs or members and/or the one or more engagement apertures in the discs or member being cut from the same.

Preferably the one or more shimmer discs or members are cut from the material using a laser cutting machine. Preferably the engagement aperture, cuts and/or one or more cut outs are cut in each shimmer disc or member using a laser cutting machine.

Preferably the image and/or design is printed onto the support member and/or the shimmer disc or member material using an ultra violet (UV) curable printing process.

In one embodiment the material on which the one or more shimmer discs or members are printed or provided on is placed front face or image/design face down in the cutting machine or laser cutting machine, and/or it can be placed rear face down and/or image design face up in the cutting machine or laser cutting machine.

Preferably once the shimmer discs or member are cut, the support member is located on top of the cut discs or members, thereby allowing engagement of the discs or members onto the engagement means on the support member.

In one embodiment the imagery is printed on the reverse or rear surface of the support member and/or the one or more shimmer discs or members.

In one embodiment the front of the support member is pushed against the rear surface of the shimmer discs or members in order to allow the discs or members to engage on the engagement means in use.

Preferably pressure applying means, such as for example, a plate, jig, mat and/or the like can be used to apply a force or pressure necessary to engage the one or more shimmer discs or members onto the support member in use.

Preferably two or more shimmer discs or members, and further preferably all the shimmer discs or member required on a support member can engage on the engagement means of the support member simultaneously or substantially simultaneously.

Once the support member is lifted from the cutting machine, the discs or members are already engaged with the support member.

Preferably the cut shimmer discs or members remain in the cutting machine during attachment of the support member to the same. The process of engagement typically takes approximately 30 seconds, compared to a few hours with the conventional process.

It will be appreciated that the shimmer discs or members are any light reflective element that can be any suitable size, shape and/or design and which are capable of moving in an air or fluid flow. For example, the shimmer disc or member could be considered to be a sequin, mosaic member and/or the like that could be used to form a mosaic image, shimmer image and/or the like.

With a shimmer disc or member attached to the engagement means in use, the disc is capable of moving forwards and backwards relative to the front surface of the support member and/or undergo swivel and/or pivotal movement from side to side or left to right with respect to the front surface of the support member. This movement takes place while maintaining the location of the disc or member on the engagement means.

In one embodiment, at least part of the shimmer disc or image apparatus is provided in a liquid and/or fluid and movement of the liquid or fluid creates movement of the one or more shimmer discs or members in use.

In one embodiment the liquid or fluid is or includes water.

In one embodiment the liquid or fluid includes air or a gas.

In one embodiment the liquid or fluid is or includes silicone oil. This is advantageous in that it retains clarity of the liquid for an extended period of time without damaging the imagery.

Preferably the viscosity of the liquid is such that it can allow movement of the one or more shimmer discs or members therein to create a shimmer effect in use.

Preferably the shimmer disc or image apparatus is located in a reservoir of the fluid or liquid in use.

Preferably the fluid or liquid in the reservoir is at such a level that the one or more shimmer discs or members are entirely or substantially entirely covered or surrounded by the fluid or liquid.

Preferably fluid flow means are provided to generate or aid movement of fluid and/or liquid relative to the at least one shimmer disc or member and/or contained within the reservoir in use to generate or aid movement of the shimmer disc or member in use.

In one embodiment the fluid flow means can include any or any combination of one or more fans, air stones, porous stones, gas or bubble generating means, wave and/or current generating means and/or the like.

According to a second aspect of the present invention there is provided a method of producing shimmer disc imagery.

According to a third aspect of the present invention there is provided a method of using or assembling shimmer disc or image apparatus, said shimmer disc or image apparatus including a support member; at least one shimmer disc or member; engagement means provided on or associated with the support member and/or shimmer disc or member, said method including the steps of engaging the at least one shimmer disc or member to the support member in use via the engagement means to form an engaged position; the support member, engagement means and/or the at least one shimmer disc or member arranged such that when engaged, at least part of the at least one shimmer disc or member is movable relative to the engagement means and/or support member in use, characterised in that said at least one shimmer disc or member is arranged such that at least part of the same is able to flex in use and/or is resiliently biased to the engaged position in use.

According to a fourth aspect of the present invention there is provided a shimmer image produced by shimmer image apparatus.

According to further independent aspects of the present invention there is provided a shimmer disc or member; and a support member for at least one shimmer disc, member and/or imagery.

Embodiments of the present invention will now be described with reference to the accompanying figures, wherein:

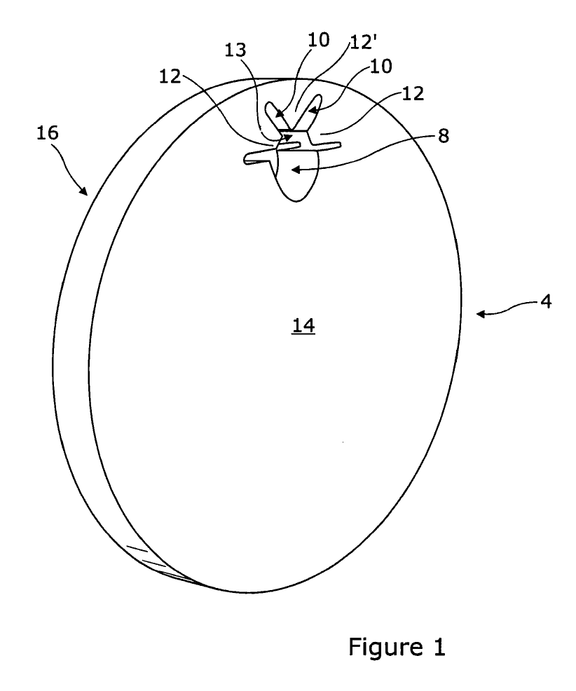

FIG. 1 is a perspective view of a shimmer disc according to an embodiment of the present invention;

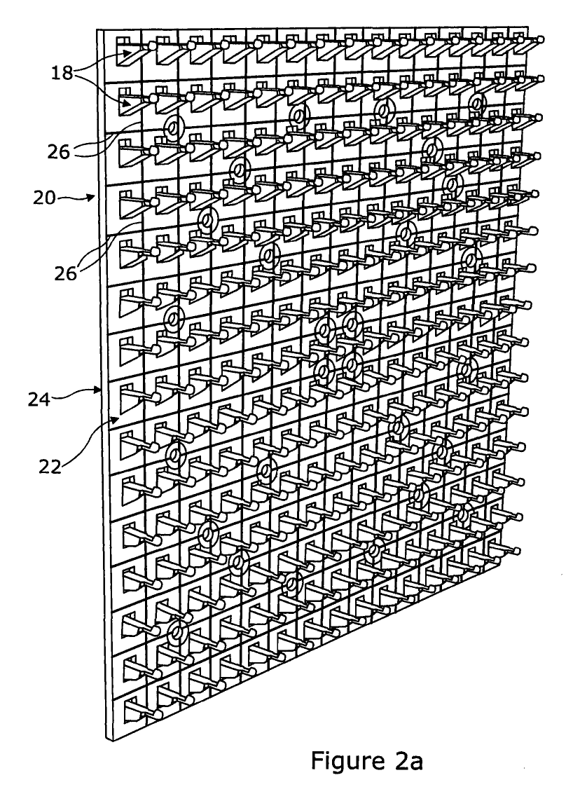

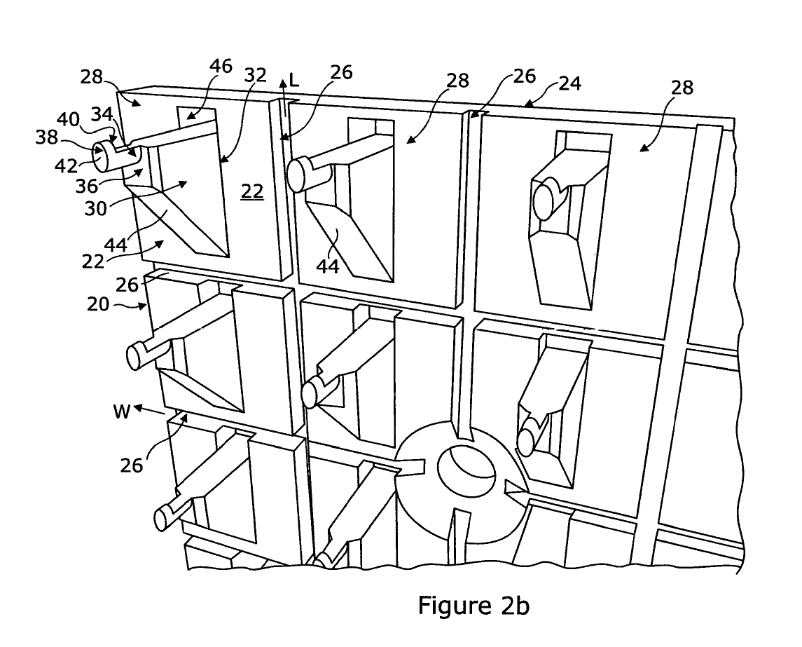

FIGS. 2a and 2b show a perspective front view and an enlarged perspective view of the support member according to an embodiment of the present invention respectively;

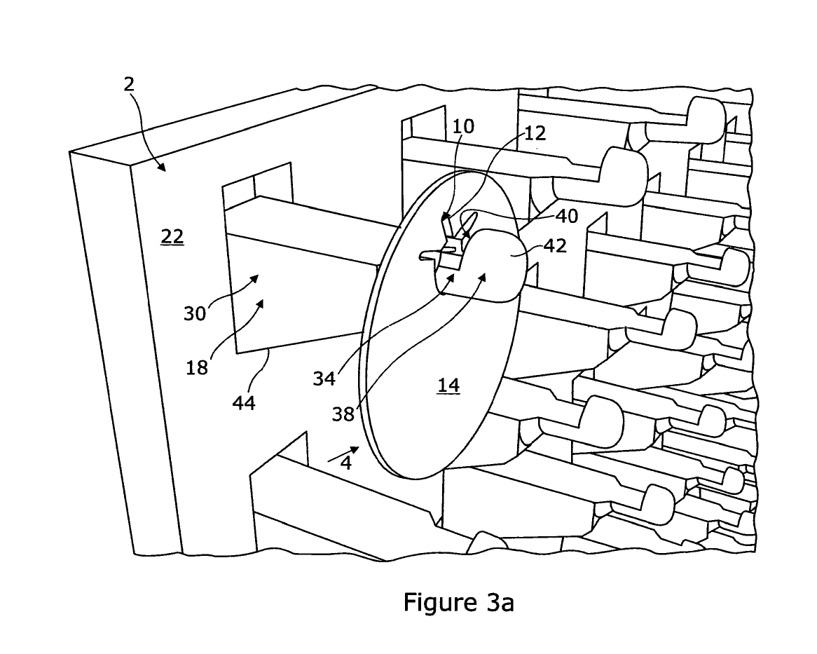

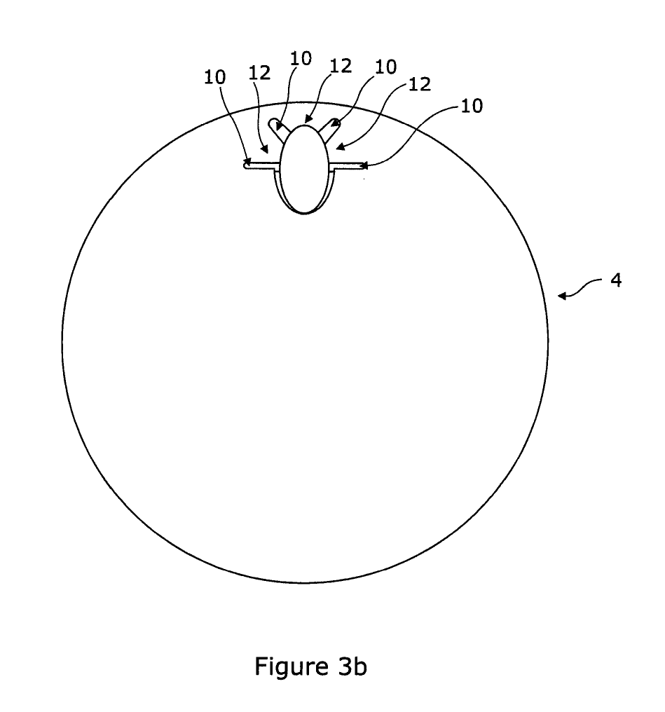

FIGS. 3a and 3b show an enlarged view of the shimmer disc in FIG. 1 engaged onto the support member in FIG. 2 in use, and a front view of the shimmer disc engaged to a head end of the engagement means in use;

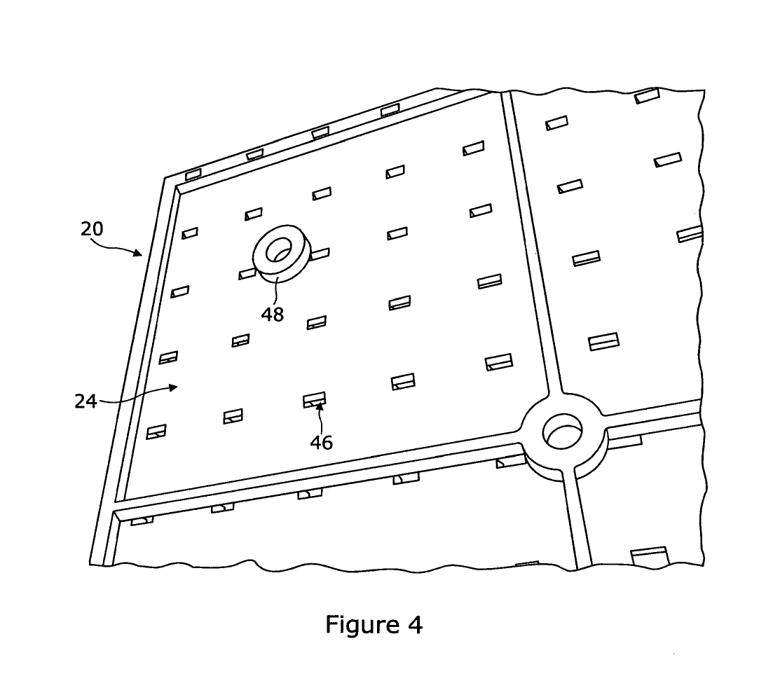

FIG. 4 is a rear view of the support member in FIG. 2;

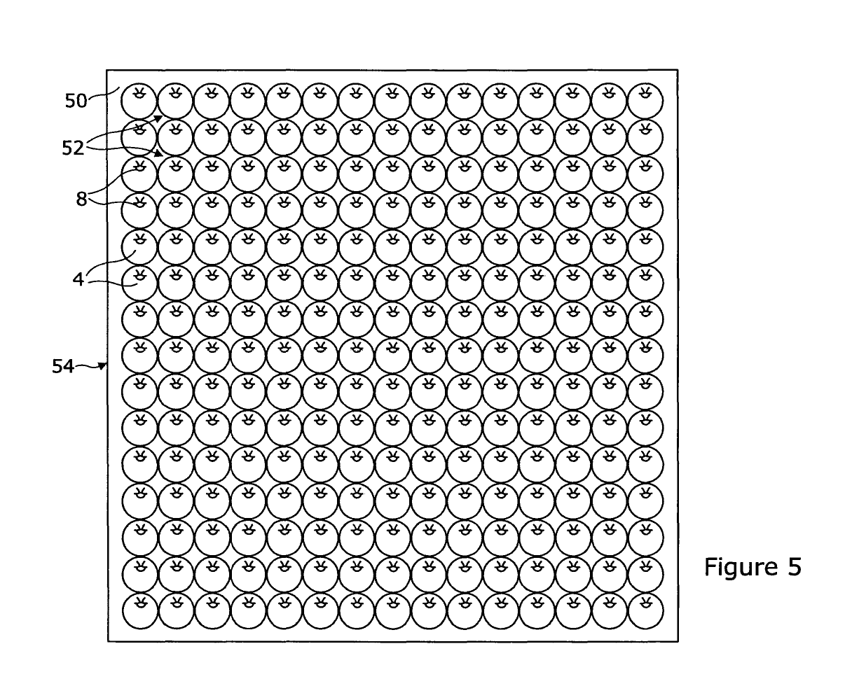

FIG. 5 is a plan view of the shimmer disc material which has been cut to shape prior to the support member being attached to the same;

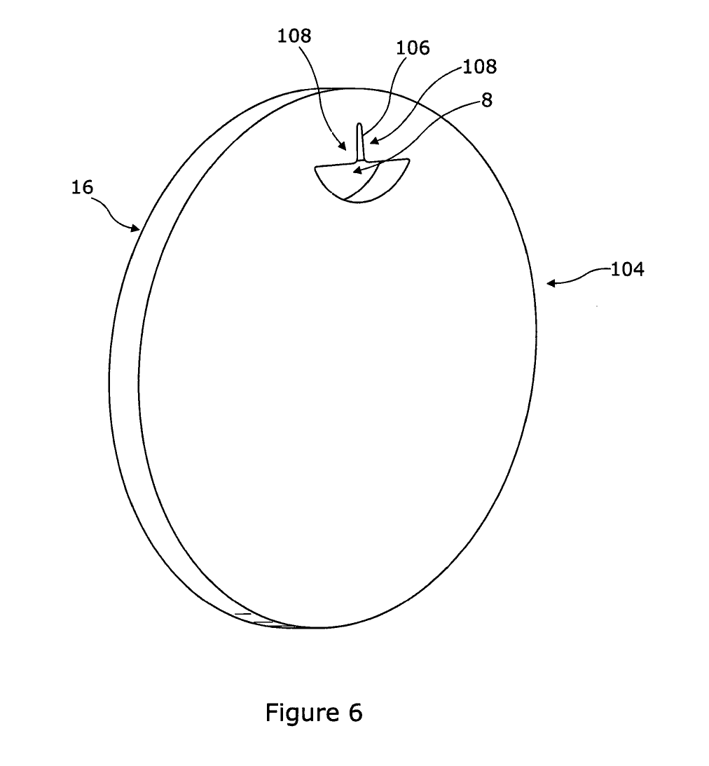

FIG. 6 is a perspective view of a shimmer disc according to further embodiment of the present invention; and

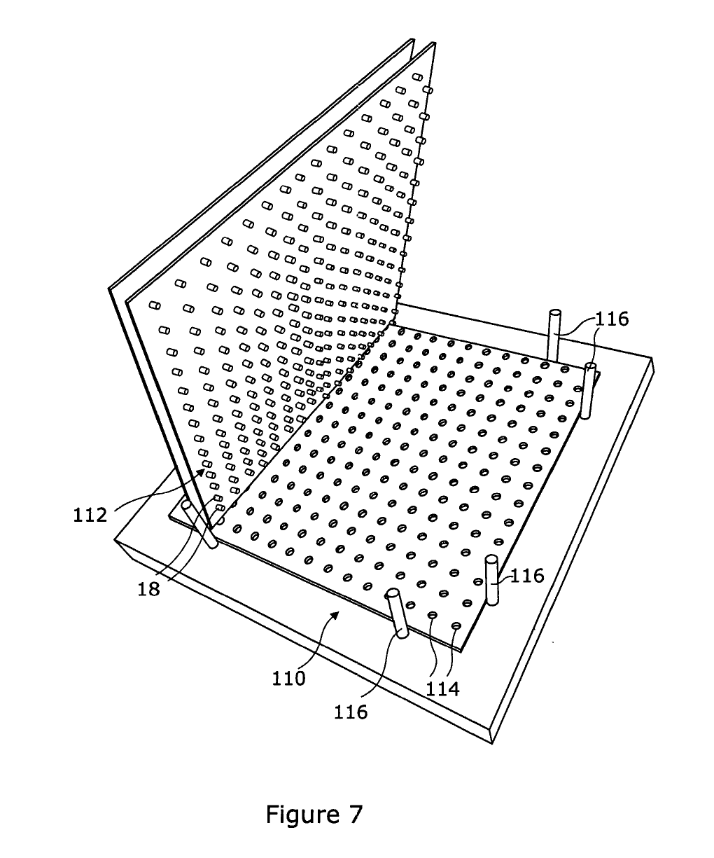

FIG. 7 is an example of a jig that can be used with the support member to allow the shimmer discs to be engaged to the support member in use.

Referring to the figures, there is illustrated shimmer disc imagery apparatus 2 comprising a plurality of shimmer discs 4 (only one of which has been shown for the purposes of clarity in some of the figures) and a support member 6.

Each shimmer disc 4 is circular in shape and has an engagement aperture 8 located adjacent a top edge of the disc. A lower part or half of the aperture 8 is semi-circular in shape, such that the lower edge of the aperture is curved. An upper part or half of the aperture 8 has flexing means in the form of a plurality of spaced apart cut outs 10 extending radially outwardly from the aperture, creating flexible protrusions 12 therebetween. The protrusions 12 protrude inwardly of the aperture 8.

A top central protrusion 12′ is ‘V’ shaped in form and the lower point 13 of the ‘V’ acts as a rocker or pivot on a top surface of a neck portion 34, as will be described in more detail below.

In this example, shimmer disc 4 is formed from a polyester sheet material that has a metallised surface provided on at least a front surface of the material. However, it will be appreciated that the material from which the shimmer disc is formed can be any material which allows light to be reflected from the same, such that it can create a shimmer effect on movement of the same in use. Each shimmer disc is approximately 13 mm in diameter in this example. It has a front surface 14 and a rear surface 16.

Each shimmer disc 4 is engaged to engagement means in the form of an engagement post 18 in use. A plurality of engagement posts 18 are integrally formed on a support member 20. The support member 20 is a board or plate like structure in the illustrated example.

Support member 20 has a front surface 22 and a rear surface 24. The engagement posts 18 are spaced apart in a uniform arrangement and protrude outwardly from the front face 22. All the posts 18 in a horizontal or width direction are aligned, and all the posts 18 in a vertical or length direction are aligned, thereby forming a grid like arrangement.

The posts 18 protrude perpendicularly to the front surface 22 in the illustrated embodiment.

Frangible means in the form of channels 26 can be defined both lengthwise ‘L’ and widthwise ‘W’ on support member 20, as shown in FIG. 2b. The channels 26 provide a weakened area of the support member 20 having less depth (distance between the front surface 22 and the rear surface 24), thereby allowing the support member to be easily cut or broken along the channels. This increases the ease with which the dimensions of the support member 20 can be altered according to the size of the imagery to be created using the shimmer discs 4 in use. The channels 26 define a relatively protruding tile member 28 between the channels 26 and each tile member 28 has an engagement post 18 located centrally thereof.

FIG. 3a shows an embodiment of the support member without frangible means.

Each engagement post 18 is typically identical in form on the support member 20. The post 18 comprises a body portion 30 having a first end 32 integrally formed with the support member 20 and protruding perpendicularly outwardly relative to the support member. A neck portion 34 protrudes outwardly from a second end 36 of body portion 30. Neck portion 34 is typically perpendicular to second end 36. A head portion 38 is provided at a free end of post 18 and is integral with neck portion 34.

The dimensions of head portion 38 are larger than the dimensions of neck portion 34. In use, head portion 38 is pushed through the aperture 8 of shimmer disc 4 and the disc locates on the neck portion 34. The flexible protrusions 12 adjacent aperture 8 on disc 4 flex outwardly from the front, planar surface 14 of disc 4 when the head portion 38 is located through aperture 8 from rear surface 16, thereby making aperture 8 larger during this process. Once the head portion 38 is located through the aperture, the protrusions 12, and particularly the V-shaped protrusion 12′ acting as a rocker engage against the neck portion of post 18. The resilient biasing force of the protrusions 12, 12′ force them into engagement with the neck portion 34. The rear surface 40 of head portion 38 creates a shoulder or stop portion relative to the neck portion, thereby preventing accidental removal of the shimmer disc from post 18 via the head portion 38 in use. The second end 36 of the body portion 30 limits movement of the disc 4 in a rearwardly direction towards the support member 20, due to its size being larger than that of the aperture 8 of the disc.

A front surface 42 of head portion 38 is typically convexed or curved in shape to increase the ease with which the same can be located through the disc aperture 8 in use.

A base surface 44 of body portion 30 is angled towards front surface 22 of the support member, thereby providing the body portion 30 with a narrowing taper from surface 22 towards the engagement post 18. This creates space to allow the shimmer disc 4 to move freely, such as rocking backwards and forwards relative to support member 20 and/or rocking from side to side relative to support member 20, when located in place on the neck portion 34 of post 18.

An aperture 46 is optionally defined between front and rear surfaces 22, 24 of support member 20 to allow the support member to be removed from the injection mould tooling in use. This aperture 46 does not typically perform any other function.

Attachment means in the form of apertures 48 are defined between front and rear surfaces 22, 24 of support member 20 to allow screws to be located through the same for attachment of the support member 20 to a suitable surface in use.

In order to produce the shimmer disc imagery, a plain foil sheet 50 is printed with a desired image on the same using UV curable printing. The printed sheet is then placed in a laser cutting machine with the foil placed such that the printed image faces downwardly in the machine (or away from the cutters). A plurality of shimmer discs 4 and apertures 8 are then cut into the foil, as shown by FIG. 5.

Without moving the discs 4 from their cut position, the front surface 22 of support member 20 is located onto the rear surface 16 of the discs 4, and a downward pressure is applied. This forces the head portion 38 of each engagement post 18 through aperture 8 of each disc 4 and locates the disc onto the neck portion 34 of the posts 18. All the discs are engaged simultaneously on the support member. The printed image on the foil is therefore visible on the front surfaces of the discs 4 when the front of the support member 20 is viewed by a user.

Since there are gaps 52 defined between the circular discs 4 on the sheet 50, approximately 80% of the printed image is not transferred onto the discs 4 when cut. With the waste foil material removed from around the cut discs 4, part of the printed image is therefore lost. However, in one embodiment, the same printed image that is printed onto foil 50 can also be printed onto the front or rear surfaces of the support member 20. Thus, a user can see the entire image when the support member 20 is viewed from the front of the apparatus as a result of the combination of the image parts on the disc and the image on the front/rear faces of the support member.

The size of the support member is typically the same as the size of the template 54 used for cutting the foil. This allows the foil and the support member to be aligned, such that every cut disc is able to located with an engagement post 18 on the support member 20.

In one example, up to 225 shimmer discs can be simultaneously or substantially simultaneously located onto the engagement posts of the support member in use. This process takes approximately 30 seconds to locate all the shimmer discs onto the support member, compared to approx. 2.5 hours if a user had to do the same manually.

With the shimmer discs 4 located on the engagement posts 18, air flow around the discs allows the discs to move. Light is reflected from the front surface 14 of the discs, thereby creating a shimmer effect when viewed by a user.

Since both the support member and the shimmer discs can be printed with an image thereon, the intricacy and detail of the image is significantly improved compared to prior art shimmer discs. This allows the detail and visual effect of the shimmer imagery to be appreciated by a user when standing closer to the imagery than with the prior art.

The image printed onto the discs can be any or any combination of one or more images, designs, text, photographs, numbers, colours, symbols and/or the like.

Since the discs can be produced much smaller than conventional shimmer discs, the resulting aesthetic effect is significantly magnified.

Referring to FIG. 6, there is illustrated a further example of a shimmer disc 104 according to an embodiment of the present invention. The shimmer disc 104 has an engagement aperture 8 located adjacent a top edge of the disc. The lower part of the aperture 8 is semi-circular in shape. An upper part of the aperture has a single cut 106 extending radially from the aperture 8, creating flexible protrusion portions 108 either side of the same. The protrusion portions 108 act as pivot points on the top surface of the neck portion of the support member in use as previously described.

Referring to FIG. 7, there is illustrated an example of a jig 110 that can be used to apply the shimmer discs 4, 104 onto a support member 112. The jig 110 has a plurality of apertures 114 defined thereon which are arranged in the same grid like arrangement as the engagement posts 18 on support member 112. Positioning means in the form of upright posts 116 are arranged around the apertures 114 to allow the support member 112 to be located therebetween in use.

A sheet of shimmer disc material can be placed on jig 114. The position of the apertures 8 cut into the shimmer disc material are typically aligned with the apertures 114 defined on the jig 114. The front surface of the shimmer disc material is typically located in abutting relationship with the top surface of jig 114. The front surface of the support member 112 is then located on the jig 114, such that the support members 112 locate through the apertures 8 on the shimmer disc material and the free ends of the support members 112 locate at least partially in the apertures 114 on the jig. Pressure is applied on the rear surface of the support member in a direction towards the jig 114, thereby forcing the support members 112 through the apertures 8 and engaging the same together as previously described.

1. Shimmer disc or image apparatus, said shimmer disc or image apparatus including a support member; at least one shimmer disc or member; engagement means provided on or associated with the support member and/or shimmer disc or member for engaging the at least one shimmer disc or member to the support member in use to form an engaged position; the support member, engagement means and/or the at least one shimmer disc or member arranged such that when engaged, at least part of the at least one shimmer disc or member is movable relative to the engagement means and/or support member in use, characterised in that said at least one shimmer disc or member is arranged such that at least part of the same is able to flex in use and/or is resiliently biased to the engaged position in use.

2. Apparatus according to claim 1, wherein the engagement means provided on or associated with the at least one shimmer disc or member is an aperture defined on or through said shimmer disc or member.

3. Apparatus according to claim 2 wherein the engagement aperture, or at least part of the engagement aperture, provided on or associated with the at least one shimmer disc or member is movable from a disengaged position, wherein the engagement aperture is a relatively small size, to an engaged or an engaging position, wherein the engagement aperture is a relatively large size.

4. Apparatus according to claim 1 wherein the engagement means, resilient biasing means and/or flexing means provided on or associated with the at least one shimmer disc or member includes one or more cuts or cut out portions in communication with the engagement aperture.

5. Apparatus according to claim 4 wherein the material of the shimmer disc or member between the cut or cut outs form one or more protrusion portions that are capable of flexing and/or moving in use.

6. Apparatus according to claim 5 wherein one or more of the protrusion portions acts as a rocker or pivot member when it engages with a surface of the engagement means on the support member in use to allow the shimmer disc or member to move.

7. Apparatus according to claim 1 wherein the engagement means provided on or associated with the support member includes at least one body portion which is attached or integrally formed with the support member and protrudes outwardly therefrom, and a head or engagement end that protrudes outwardly from the body portion, wherein the head or engagement end of the body portion is locatable through the engagement means of the shimmer disc or member in use to form an engaged position.

8. (canceled)

9. Apparatus according to claim 7 wherein a rear surface of the head or engagement end creates a shoulder or stop portion to prevent accidental removal of the shimmer disc or member therefrom once located thereover in the engaged position in use.

10. Apparatus according to claim 7 wherein the at least one body portion has a narrowing taper from a first end attached to or integrally formed with the support member, towards a second free end, to allow the shimmer disc or member to move relative to the same when in the engaged position in use.

11. (canceled)

12. (canceled)

13. Apparatus according to claim 1 wherein the support member includes a plurality of engagement means arranged a spaced distance apart thereon.

14. (canceled)

15. Apparatus according to claim 1 wherein attachment means are provided on or associated with the support member for allowing the support member to be attached to a surface in use.

16. (canceled)

17. (canceled)

18. Apparatus according to claim 1 wherein the support member is formed from an optically clear or transparent material, a substantially optically clear or transparent material and/or from a plastic material.

19. Apparatus according to claim 1 wherein the at least one shimmer disc or member is formed from or includes any or any combination of a sheet like material, a material made from or including a metallic material thereon, a metallic foil material, a material having a relatively high gloss surface finish on at least a front surface thereof so that light can be reflected from the same, a non-metallised material, a plastic material, a plastic film material, a transparent or substantially transparent material or is circular or substantially circular.

20. Apparatus according to claim 1 wherein the at least one shimmer disc or member is approximately 100 μm thick and/or less than 30 mm in diameter or width.

21. (canceled)

22. (canceled)

23. (canceled)

24. Apparatus according to claim 1 including a liquid and/or fluid, and/or a reservoir in which the liquid and/or fluid us located in use, in which at least part of the apparatus is located in use.

25. Apparatus according to claim 24 wherein the liquid and/or fluid is water, air, gas, and/or silicone oil.

26. Apparatus according to claim 1 wherein fluid flow means are provided to generate or aid movement of fluid and/or liquid relative to the at least one shimmer disc or member in use to generate movement of the at least one shimmer disc or member in use.

27. (canceled)

28. A method of using or assembling shimmer disc or image apparatus, said shimmer disc or image apparatus including a support member; at least one shimmer disc or member; engagement means provided on or associated with the support member and/or shimmer disc or member, said method including the steps of engaging the at least one shimmer disc or member to the support member in use via the engagement means to form an engaged position; the support member, engagement means and/or the at least one shimmer disc or member arranged such that when engaged, at least part of the at least one shimmer disc or member is movable relative to the engagement means and/or support member in use, characterised in that said at least one shimmer disc or member is arranged such that at least part of the same is able to flex in use and/or is resiliently biased to the engaged position in use.

29. The method of claim 18 wherein two or more shimmer discs or members engage with the engagement means of the support member simultaneously or substantially simultaneously.

30. A shimmer disc or member according to claim 1.
